(19) United States
(12) Patent Application Publication
(10) Pub. No.: US 2024/0229989 A9
(43) Pub. Date: Jul. 11, 2024

(54) SEALING RING POSITIONING DEVICE

(71) Applicant: Petróleo Brasileiro S.A. -Petrobras, Rio de Janeiro (BR)

(72) Inventor: ANDRE LUIZ BEVILAQUA SANTANA, MACAÉ (BR)

(73) Assignee: Petróleo Brasileiro S.A. -Petrobras, Rio de Janeiro (BR)

(21) Appl. No.: 18/489,041

(22) Filed: Oct. 18, 2023

(30) Foreign Application Priority Data
Oct. 19, 2022 (BR) BR1020220212236

(51) Int. Cl. F16L 23/00; B63G 8/00; F16L 23/22

(52) U.S. Cl. CPC F16L 23/003; B63G 8/001; F16L 23/22; B63G 2008/005

(57) ABSTRACT

A sealing ring positioning device that, operated by a remotely operated vehicle (ROV), allows sealing rings to be installed, in the subsea environment, in a groove of a flange of a first pipeline to be interconnected to a second pipeline. The sealing ring positioning device is provided with an upper portion that is presented as a handle by which the ROV handles the device in a subsea environment, a lower portion having a semicircle shape and configured to hold the sealing ring to be arranged in the flange groove in a subsea environment, and a middle portion including a groove holding a magnet that is configured to hold the device firmly positioned in the pipeline in a subsea environment, during the arrangement of the ring in the groove of the flange.

### CROSS-REFERENCE TO RELATED APPLICATION

This application claims, under 35 U.S.C. § 119(a), priority to and the benefit of Brazilian Patent Application No. 10 2022 021223 6, filed Oct. 19, 2022, which is incorporated by reference herein in its entirety.

### FIELD OF APPLICATION

The present invention pertains the field of auxiliary tools applied in connection operations between subsea pipelines, remotely, through an ROV (Remoted Operated Vehicle, or remotely operated vehicle). More specifically, the present invention relates to the technical field of devices for installing sealing means on flanges of subsea pipelines to be interconnected.

### STATE OF THE ART

The subsea environment consists of a plurality of interconnected systems and machines. In particular, subsea pipelines are responsible for moving fluids produced in an oil and gas field. Consequently, there is a constant need for changes and maintenance that allow and maintain the interconnection between the pipelines, to guarantee ideal safety conditions and the continuity of production.

In particular, to guarantee sealing in flanged connections between subsea pipelines, metal rings compatible with the “grooves” of the machined flanges are used, commonly in accordance with a regulatory standard for manufacturing flanges, for example, API 17D, API 6A or ASME B16.5. In practice, the grooves are arranged circularly on the flange, in order to allocate the space due to the receipt of a sealing ring, facilitating joining operations between pipelines, in order to promote ease of assembly, disassembly and maintenance.

Notwithstanding, in the current technique, the installation of the sealing rings in flanged connections is normally done manually, precisely, on the deck of a vessel reserved for assistance in that particular operation. For example, the installation of the sealing ring takes place on the work table of a PLSV (Pipe Laying Support Vessel) type vessel, so that before a given pipeline line is launched onto the design track, the ring is positioned manually and individually by a collaborator, before installing the studs, followed by tightening the screws/studs, which specifically completes the connection of the pipelines through the flanged connection.

However, in certain scenarios it is not possible to collect the pipeline that needs maintenance, or that will be subjected to a different interconnection, for example, to the table of the support vessel for mounting the sealing ring in the conventional way. For example, in cases where an old pipeline must be connected to a new pipeline, it is common for said old pipeline to be in an abandoned condition on the seabed, where other operating lines are overlapping this pipeline. For these scenarios, capturing and guiding this pipeline to the support vessel is completely unfeasible. It is in this scenario that the technical solution proposed by the present invention applies.

In particular, the present invention allows a sealing ring to be positioned between flanges of a pipeline in a subsea environment, completely remotely via an ROV, enabling an ideal seal for a subsequent union of this pipeline to a second pipeline.

In addition to the technical problem discussed above, another deficiency was latent in the state of the art, precisely related to the execution time of the operation of connecting the sealing ring to the flange of a pipeline to be launched. Precisely, in addition to the entire system of capturing and transporting the pipeline to the support vessel, an operator needed to apply an adhesive glue to the flange groove, and wait a minimum drying time of approximately 8 hours. Even so, even observing this drying time, the loss of the ring was observed during the launching operation. As a consequence, in addition to the loss of material and, additionally, of resources related to the availability of the support vessel, it was necessary to collect the pipeline again and completely repeat the entire manual process, running the same risks of loss in the new launch.

As possible solutions to technical problems related to the field of the invention, documents U.S. Pat. No. 4,705,331A and CN103834949B are found in the prior art.

In particular, document U.S. Pat. No. 4,705,331A describes an automatically actuating clamp for attachment to a member disposed in a subsea environment. In one of its presentation embodiments, a subsea transport apparatus is described for attaching to a remotely operated vehicle (ROV) to engage, transport and install an anode installation assembly or a piping repair assembly in the subsea environment. U.S. Pat. No. 4,705,331A also provides for a pair of spaced longitudinally aligned clamps mounting a pair of elongated semicircular cross-section sealing pads to the inner surfaces of opposing longitudinally aligned members for clamping over a pipeline leak to effect a temporary seal. However, when observing its description, it is noted that this document is not specifically aimed at enabling the positioning of a sealing ring in the groove of a flange in a subsea environment, as proposed by the present invention. Although operations carried out to provide a seal to a subsea pipeline are mentioned, it is not specified that this is a ring-type seal on a flange at the end of said pipeline. In addition, despite U.S. Pat. No. 4,705,331A mentioning the intention of the manipulation by means of an ROV, it should be noted that the physical structure of the present invention is very different from the assembly described in such a publication. Its description provides a device with a multiplicity of component elements, which results in a magnitude opposite to the proposal of the present invention, in the form of a practically unique machined metallic structure. In addition, although a structure of “arms” in a semicircle is observed in this document, this structure presents movement and is linked to the function of the other elements that make up the device. In the present invention, in turn, it is observed that the semicircle portion is a static portion already programmed to adapt the size of a sealing ring to be made available to the flange. Finally, no magnetic structure is mentioned or predicted in that document.

Document CN103834949B refers to a quick installation multifunctional rim and a method of using the same. The rim comprises two U-shaped clips (1), the two clips (1) secured by a fixed plate (2). The multifunctional quick installation rim is mentioned as simple in structure, convenient to use, the cost of subsea construction can be greatly reduced, the workload of subsea construction can be decreased, and the work efficiency can be improved. However, as observed in the previously discussed document, it is noted that this document does not present a description aimed at providing the positioning of a sealing ring in the groove of a flange in a subsea environment. Precisely, taking into account, for example, the uniquely machined structure of the invention and the proposed positioning determined through a magnet, it is possible to conclude that there would be no motivation for a technician skilled on the subject to promote changes based on this document, in order to achieve the determinations of the present invention.

Therefore, it is clear that the state of the art lacks a device that allows the safe and precise arrangement of a sealing ring in a groove of a flange of a subsea pipeline, which will be interconnected to another pipeline, eliminating the need for actuation of divers, with the corresponding operation being completely remote, as well as free from losses due to the sealing ring detaching during launching into the subsea environment, for example.

### BRIEF DESCRIPTION OF THE INVENTION

The present invention describes a sealing ring positioning device that is characterized by installing a sealing ring on a flange of a pipeline, wherein said device comprises a lower portion structured in a semicircle shape, and a middle portion comprising a magnet, the magnet arranged in a laterally displaced position in relation to the semicircle of the lower portion. Additionally, the device comprises an upper portion that is presented as a handle, preferably in the shape of a “T”. Optionally, the device may comprise a strap at the upper portion of the “T” of the handle of the upper portion.

In a preferred embodiment, the device is handled by an ROV and operates in a subsea environment, arranging the sealing ring in a groove of a flange of a first subsea pipeline to be interconnected with a second subsea pipeline.

Still in a preferred embodiment, the middle portion holds the magnet in a groove arranged in a preferably square plate, wherein one of the sides of this plate comprises the projection of a side wall. Meanwhile, the semicircle of the lower portion can be manufactured preferably coincident with or as close as possible to the outer diameter of the sealing ring.

In a preferred, but not limiting, embodiment of the invention, a layer of high-performance glue can be applied to the semicircle region on which the ring will be deposited, prior to the launching in a subsea environment; the sealing ring being deposited on this glue, wherein, optionally, the application of this glue is repeated in the semicircle region and, additionally, a new layer is applied in the contact regions of the sealing ring and the semicircle, as well as a tape to involve both parties. Subsequently, the device of the invention is launched into the subsea environment in a tool basket with a seven-function manipulator and an ROV, for example, wherein the ROV, by means of the strap above the “T”, guides the device to the flange of the pipeline to be subjected to the operation, whereas, by using the handle, positions the sealing ring adjusted to the groove of the flange of the pipeline to be subjected to the operation. It is observed that the device disclosed herein is removed only after completing the positioning of the sealing ring on the flange of a first pipeline, after approaching a second component pipeline of an interconnection operation, and after passing stud screws between the interconnected flanges.

### BRIEF DESCRIPTION OF FIGURES

FIG. 1 is a graphic representation in perspective of the sealing ring positioning device of the present invention, in the condition without the sealing ring positioned.

FIG. 2 is a graphical representation in perspective of the sealing ring positioning device of the present invention, in the condition with the sealing ring positioned.

FIG. 3 is a graphic representation in perspective of the sealing ring positioning device of the present invention, in an angled positioning that provides a lower view, in the condition with the sealing ring positioned.

FIG. 4 is a graphic representation in side view of the sealing ring positioning device of the present invention.

FIG. 5 is an exemplary photograph of the sealing ring positioning device of the present invention adapted to receive an auxiliary strap for manipulation by the ROV, and, therefore, the sealing ring to be positioned on the flange of the subsea pipeline.

FIG. 6 is an exemplary photograph of the sealing ring positioning device of the present invention positioned on the flange receiving the sealing ring.

FIG. 7 is a second exemplary photograph, closer than FIG. 6, of the sealing ring positioning device of the present invention positioned on the flange receiving the sealing ring.

FIG. 8 is a second exemplary photograph, in a lateral positioning, of the sealing ring positioning device of the present invention positioned on the flange receiving the sealing ring.

### DETAILED DESCRIPTION OF THE INVENTION

The present invention refers to a sealing ring positioning device that, operated by means of an ROV, allows sealing rings to be installed, in the subsea environment itself, in a groove of a flange of a first pipeline to be interconnected to a second pipeline. By means of the device provided by the invention, the need to collect and transport a pipeline to a support vessel is eliminated in order to then carry out a manual arrangement of the sealing ring on the flange, which often failed due to the fact that the ring came loose in the subsequent launch operation.

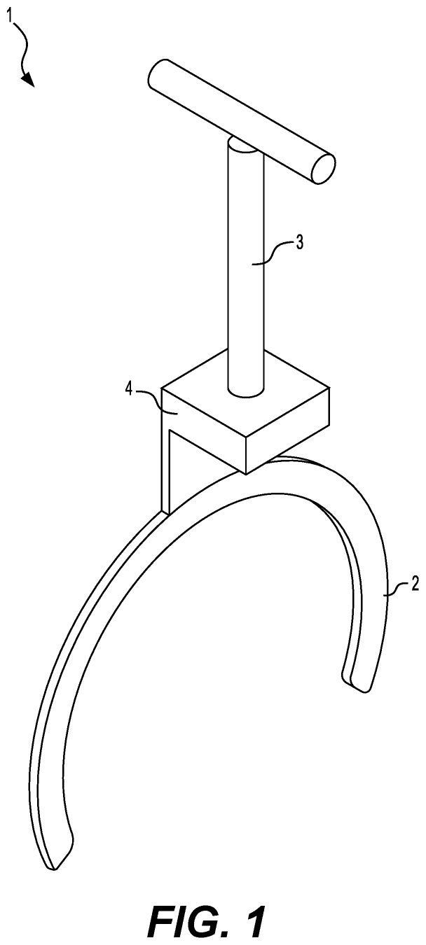

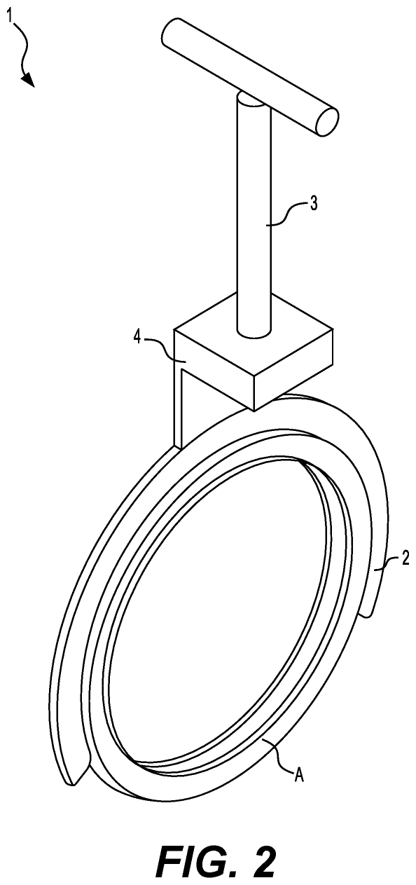

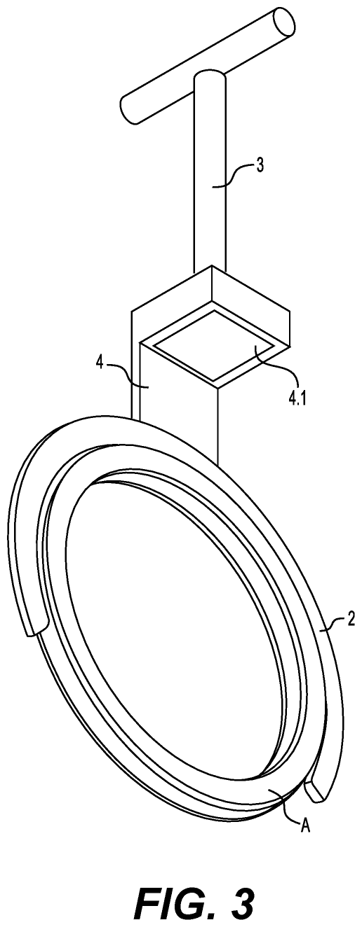

As shown in FIGS. 1, 2 and 3, the sealing ring positioning device 1 disclosed herein is preferably made of a metallic material, preferably a machined one. In particular, the device 1 is provided with an upper portion 3 that is presented as a handle, being the means by which the ROV handles the device in a subsea environment. Additionally, said device 1 is provided with a lower portion 2 structured in a semicircle shape, being the part of the central structure that effectively holds the ‘A’ ring to be arranged in the flange groove in a subsea environment. Furthermore, the device 1 is provided with a middle portion 4 comprising a groove holding a magnet 4.1, wherein said magnet 4.1 is the means by which the device 1 remains firmly deposited, positioned in the pipeline in a subsea environment, during the arrangement of the ring into the flange groove.

Regarding the measurements in which the device of the invention can be presented, reference is made to the composition of a subsea mesh. The subsea mesh includes pipes, pipelines, cables, etc., of different diameters. The operating principle of the invention does not vary, being understood as a device that provides the correct arrangement of a sealing ring in a groove of a pipeline flange. Therefore, respecting the necessary changes in the semicircle region of the device, device 1 will be able to serve any pipeline with a flanged connection and a groove.

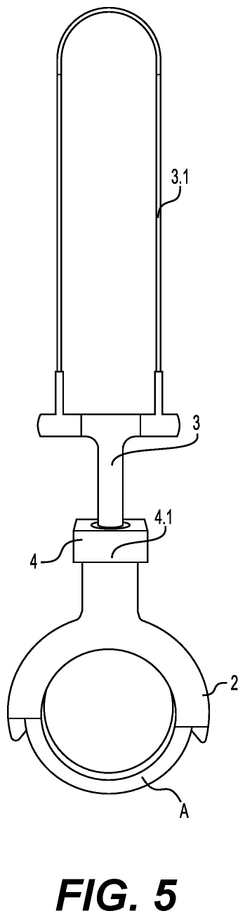

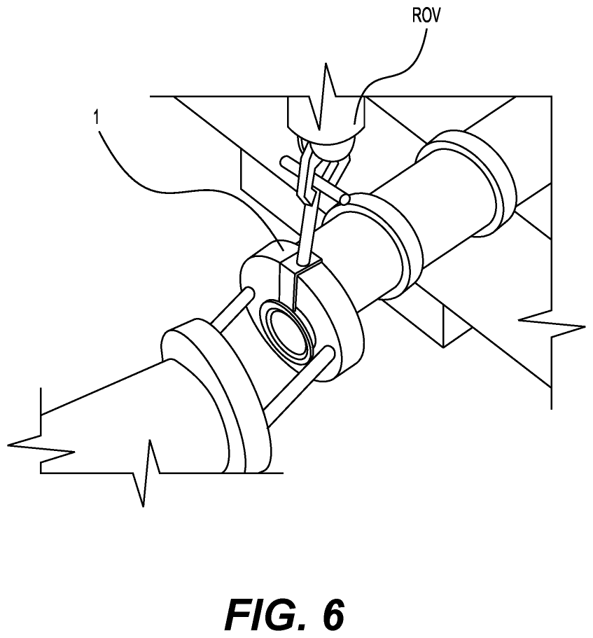

In particular, the upper portion 3, which is presented as a handle, preferably has a “T” shape, and can optionally receive a strap 3.1 arranged in the upper part of the “T”, as an additional aid for the action of handling of the ROV, especially in the initial steps of the procedure. With this strap 3.1, which is preferably as illustrated in the exemplary photograph in FIG. 5, the device is prevented from being detached during the installation of the sealing ring.

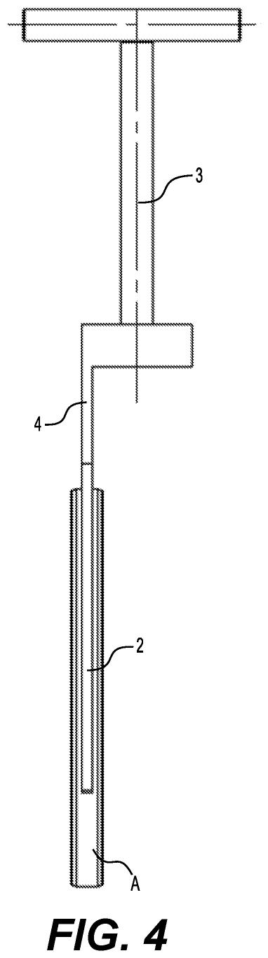

In relation to the middle portion 4, it should be noted that this is an interconnection region between the semicircle and the handle, and comprises a plate, preferably in a square shape, wherein one of the sides of this square comprises the projection of a side wall. Said wall is the means of connection with the semicircle of the lower portion 2. According the illustration proposed in FIG. 4, it should be noted that by drawing a vertical axis through the center of the handle corresponding to the upper region 3, this vertical axis passes through the center of the said square. Precisely in this square, the groove is arranged to hold the magnet 4.1, which can be linearly adjusted to the groove, optionally fixed by means of glue, for example, or other means considered to be suitable. The positioning thus described allows the magnet 4.1 to connect the device 1 in the upper region of the flange end in the subsea environment. For this positioning, the 12 o'clock position is initially ideal, although this is not a limiting designation.

Specifically in relation to the lower portion 2 structured in a semicircle shape, it should be noted that the semicircle must be manufactured in such a way as to coincide exactly with, or be as close as possible to, the external diameter of the sealing ring to be used. As mentioned above, adaptations can be made to the geometry of this semicircle, so that the device of the invention can be applied to the service of a wide range of sealing rings, such as, for example, a BX 153 ring, which is a small ring, or a ring BX 163, which is a ring with very large measurements in relation to the BX 153. Again, the operating principle of the device of the invention does not change, and it should only be noted that good functioning is observed when the outer diameter of the sealing ring “A” coincides with or is very close to the geometry of the semicircle, in order to allow the same to fit into the semicircle.

In the preferred embodiment of the present invention, which is discussed here as exemplary or illustrative, the upper 3, middle 4 and lower 2 portions are machined in order to fully compose the sealing ring positioning device 1. Ideally, the device can be placed attached, for example, in a vise bench tool and, subsequently, the area of the semicircle to receive the sealing ring “A” is cleaned, wherein the cleaning allows to eliminate possible dirt or paint, for example, that could eventually interfere with the fit between the semicircle and the ring “A”. Similarly, the sealing ring “A” to be used must also be cleaned and checked for integrity, in order to avoid inefficient seals.

Additionally, in the preferred embodiment of the present invention, a layer of high-performance glue is applied to the semicircle region on which the ring “A” will be deposited. Next, the sealing ring “A” is actually applied to the semicircle and, optionally, the application of glue is reinforced on the edges of the contact between these parts.

Further in the preferred embodiment as disclosed, the application of glue can be repeated and, in addition, a tape can be applied in order to physically attach and ensure the fixation of the sealing ring “A” to the semicircle. This action prevents the loss of the ring due to possible shocks during operation, and is also advantageous in the sense that the ROV can easily remove this tape in a timely manner during the ring arrangement operation.

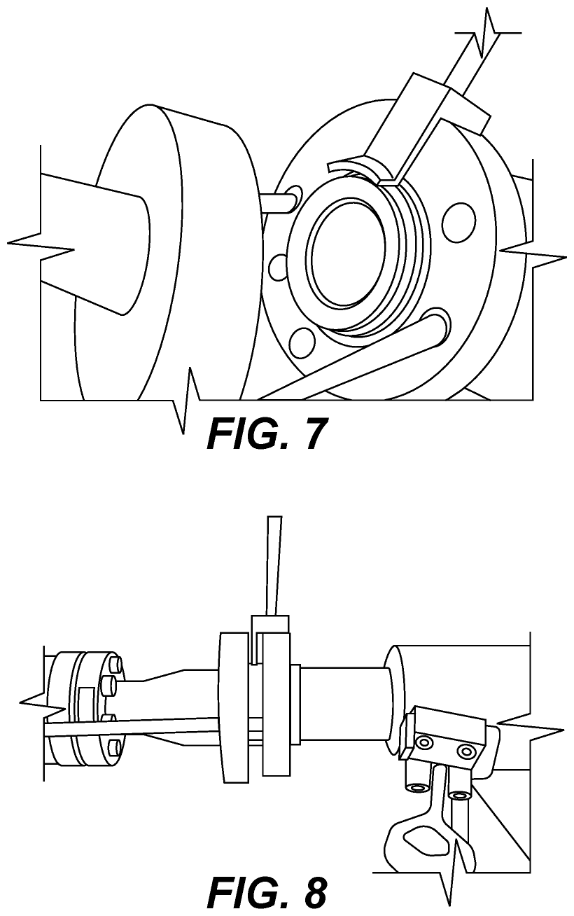

In this way, in the preferred but not limiting embodiment, the device is then launched into the subsea environment in a tool basket, for example, with a seven-function manipulator and an ROV. The strap 3.1 assists in the initial handling by the ROV, while the operation of arranging the ring “A” itself is done through the handle in the upper region 3. Therefore, through strap 3.1, the ROV guides the device close to the flange of the pipeline to be subjected to the operation. By using the handle, the ROV positions the sealing ring adjusted to the groove of the flange of the pipeline to be subjected to the operation. It should be highlighted that, at this moment, the magnet 4.1 is adhered to the upper surface of the end of the flange; so, an adequate positioning is maintained and ensured. FIGS. 7 and 8 help to illustrate this state of the device. Assuming that the operation flanges are already clean, and the sealing ring is positioned on the flange of a first pipeline, the second component pipeline of the interconnection is brought closer, the definitive stud screws are inserted and, only then, the device 1 is removed. In this way, it is guaranteed that the positioning will be ideal, eliminating false or improper seals, since the connection operation was completed with the presence of a positioning mechanism, which is the device of invention 1.

Having described the invention in terms of its preferred, exemplary and non-limiting embodiment, it is clear that a technician skilled on the subject will be able to make adaptations in light of the matter described herein, with said adaptations still encompassed by the scope of the present claims.

1. A sealing ring positioning device, comprising a lower portion having a semicircle shape, and a middle portion comprising a magnet, the magnet arranged in a laterally displaced position in relation to the lower portion, wherein the sealing ring positioning device is configured to install a sealing ring on a flange of a pipeline.

2. The device according to claim 1, further comprising an upper portion comprising a handle having a T shape.

3. The device according to claim 1, wherein a remotely operated vehicle (ROV) is configured to control the device and operate in a subsea environment, arranging the sealing ring in a groove of the flange positioned in the subsea environment to be interconnected with a second pipeline positioned in the subsea environment.

4. The device according to claim 2, further comprising a strap in an upper part of the handle.

5. The device according to claim 1, wherein the magnet of the middle portion is positioned in a groove that is arranged in a square plate, wherein one side of the plate comprises a projection of a side of a wall.

6. The device according to claim 1, a radius of the semicircle shape of the lower portion approximately corresponds to an external diameter of the sealing ring.

7. The device according to claim 2 further comprising:
a layer of high-performance glue disposed on the lower portion having the semicircle shape, wherein the sealing ring is deposited on the high-performance glue a space formed by the semicircle shape;
an additional layer of high-performance glue is applied in contact regions of the sealing ring and the lower portion; and
tape configured to wrap the lower portion and the sealing ring.

8. The device according to claim 7, wherein the device is launched into a subsea environment in a tool basket with a seven-function manipulator and a remotely operated vehicle (ROV), wherein the ROV, via straps, is configured to guide the device to the flange of the pipeline, whereas the ROV, via the handle, is configured to position the sealing ring to be adjusted to a groove of the flange of the pipeline.

9. The device according to claim 8, wherein the device is configured to be removed only upon completing the positioning of the sealing ring on the flange of a first pipeline, after approaching a flange of a second pipeline of an interconnection, and after passing stud screws between the flange of the first pipeline and the flange of the second pipeline, both of which are interconnected.
